(19) United States
(12) Patent Application Publication
(10) Pub. No.: US 2026/0365161 A1
(43) Pub. Date: Nov. 19, 2026

(54) REMOTE PARKING CONTROL DEVICE FOR VEHICLE

(71) Applicant: TOYOTA JIDOSHA KABUSHIKI KAISHA, Toyota-shi (JP)

(72) Inventors: Tatsuya SUGANO, Seto-shi (JP); Takahiro YAMAMOTO, Toyota-shi (JP); Chenyang WANG, Nagoya-shi (JP)

(73) Assignee: TOYOTA JIDOSHA KABUSHIKI KAISHA, Toyota-shi (JP)

(21) Appl. No.: 19/650,734

(22) Filed: Apr. 17, 2026

(30) Foreign Application Priority Data
May 16, 2025 (JP) 2025-082657

(51) Int. Cl. B60W 30/06; G05D 1/224; G06F 8/65; H04W 4/40; G05D 109/10; G05D 111/30

(52) U.S. Cl. CPC B60W 30/06; G05D 1/2244; G06F 8/65; H04W 4/40; B60W 2556/45; G05D 2109/10; G05D 2111/30

(57) ABSTRACT

A remote parking control device for a vehicle includes a control unit that executes remote parking control in response to a command from the communication terminal device operated by a user, and acquires and updates software of an on-board control device via wireless communication, in which the control unit is configured to: in a case where the wireless connection with the communication terminal device is completed and a situation in which software can be updated is reached, notify the user that the software can be updated; and in a case where the user is notified that the software can be updated but does not consent to the software update, enable the user to operate the communication terminal device to execute the remote parking control.

### CROSS-REFERENCE TO RELATED APPLICATION

This application claims priority to Japanese Patent Application No. 2025-082657 filed on May 16, 2025. The disclosure of the above-identified application, including the specification, drawings, and claims, is incorporated by reference herein in its entirety.

### BACKGROUND

### 1. Technical Field

The present disclosure relates to a remote parking control device for a vehicle, and more particularly, to a remote parking control device for a vehicle in which software of an on-board control device is acquired and updated by wireless communication.

### 2. Description of Related Art

In a vehicle such as an automobile, in order for the on-board control device to execute optimal control, software (control program) of the control device needs to be updated to the latest version. As a method of updating software of the on-board control device, updating via over-the-air (OTA) is known.

For example, Japanese Unexamined Patent Application Publication No. 2024-161998 (JP 2024-161998 A) discloses a technology of updating software via OTA, that is, a technology of acquiring software of an on-board control device and updating the software via wireless communication from an OTA server. The software update via OTA is performed in three steps of downloading, installing, and activating software, and user's consent is required in each step.

### SUMMARY

In a case where the vehicle is a vehicle including a remote parking control device, in a case where remote parking control is executed in a situation where software of the on-board control device is updated via OTA, the remote parking control and the software update interfere with each other. In particular, the remote parking control is hindered by power control in the software update. Therefore, the remote parking control cannot be normally executed.

The present disclosure provides a remote parking control device for a vehicle that is improved such that the remote parking control and the software update do not interfere with each other even in a case where software of the on-board control device is updated via OTA.

According to the present disclosure, there is provided a remote parking control device (10) for a vehicle, the remote parking control device (10) including a control unit (control system 24) that is wirelessly connected to a communication terminal device (44) operated by a user, is configured to execute remote parking control in response to a command from the communication terminal device (S140), and is configured to acquire software of an on-board control device (driving assistance ECU 30 or the like) and update the software via wireless communication (S80).

The control unit (control system 24) is configured to issue a command to the communication terminal device to notify the user that a software update is available (S30), in a case where wireless connection with the communication terminal device (44) is completed and a situation arises in which the software update is available (S10), and is configured to enable the user to operate the communication terminal device to execute the remote parking control without updating the software (S30, S90), in a case where the user is notified that the software update is available but does not consent to the software update (S40).

According to the configuration, in a case where the wireless connection with the communication terminal device is completed and a situation arises in which the software update is available, the user is notified that the software update is available. Therefore, the user can recognize that the software update is available, and can determine whether to update the software without executing the remote parking control.

In addition, in a case where the user is notified that the software update is available but does not consent to the software update, the user can operate the communication terminal device to execute the remote parking control without updating the software. Therefore, the user can execute the remote parking control by operating the communication terminal device, and it is possible to suppress the software update in a case where the remote parking control is executed. Therefore, since the remote parking control and the software update are not executed at the same time, it is possible to suppress interference between the remote parking control and the software update.

### Aspect of Disclosure

In one aspect of the present disclosure, the control unit (control system 24) is configured to issue a command to the communication terminal device to notify the user that the software update is unavailable (S100), in a situation where the user is allowed to operate the communication terminal device to execute the remote parking control, and in a case where the user operates the communication terminal device to execute the remote parking control (S90).

According to the aspect, in a situation where the user is allowed to operate the communication terminal device to execute the remote parking control, and in a case where the user operates the communication terminal device to execute the remote parking control, the user is notified that the software update is unavailable. Therefore, the user can recognize that the software update is unavailable in a case where the user operates the communication terminal device to execute the remote parking control.

In another aspect of the present disclosure, the control unit (control system 24) is configured not to execute the remote parking control (S80) even when the user operates the communication terminal device to execute the remote parking control (S60), in a case where the user consents to the software update (S40).

According to the aspect, in a case where the user consents to the software update, the remote parking control is not executed even when the user operates the communication terminal device to execute the remote parking control. Therefore, in a case where the user consents to the software update and the software is updated, the remote parking control is not executed even when the communication terminal device is operated to execute the remote parking control. Therefore, it is possible to suppress execution of the remote parking control and the software update at the same time, and to suppress interference between the remote parking control and the software update.

In another aspect of the present disclosure, the control unit (control system 24) is configured to issue a command to the communication terminal device to notify the user that start of the remote parking control is unavailable until the software update is completed (S70), in a case where the user operates the communication terminal device to execute the remote parking control (S60) despite having consented to the software update (S40).

According to the aspect, in a case where the user operates the communication terminal device to execute the remote parking control despite having consented to the software update, the user is notified that the start of the remote parking control is unavailable until the software update is completed. Therefore, the user can recognize that the start of the remote parking control is unavailable until the software update is completed, and it is possible to reduce a risk that the user operates the communication terminal device to execute the remote parking control.

In another aspect of the present disclosure, the control unit (control system 24) is configured to issue a command to the communication terminal device to notify the user of a time until the software update is completed by a countdown (S70), in a case where the user consents to the software update (S40).

According to the aspect, in a case where the user consents to the software update, the user is notified of the time until the software update is completed by the countdown. Therefore, the user can recognize the time until the software update is completed, and can know a timing at which the software update is completed and the remote parking control can be executed.

In the description, in order to facilitate the understanding of the present disclosure, either or both of names and reference numerals used in the embodiment described later are added in parentheses to the configuration of the disclosure corresponding to the embodiment described later. However, each of the components of the present disclosure are not limited to the components of the embodiment corresponding to either or both of the names and reference numerals added in parentheses. Other objects, features, and advantages of the present disclosure will be easily understood from the following description of the embodiments of the present disclosure with reference to the accompanying drawings.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic configuration diagram showing an embodiment of a remote parking control device for a vehicle according to the present disclosure;

FIG. 2 is a flowchart corresponding to a remote parking control program in the embodiment;

FIG. 3 is a diagram showing a communication terminal device in which a screen for consent to software update is displayed on a monitor;

FIG. 4 is a diagram showing a communication terminal device in which information on a time of a countdown until the software update is completed is displayed on a monitor;

FIG. 5 is a diagram showing a communication terminal device in which information that the remote parking control cannot be started until the software update is completed is displayed on a monitor; and

FIG. 6 is a diagram showing a communication terminal device in which information that the software update cannot be performed and a start switch of the remote parking control are displayed.

### DETAILED DESCRIPTION OF EMBODIMENTS

Hereinafter, the remote parking control device for a vehicle according to the embodiment of the present disclosure will be described in detail with reference to the accompanying drawings.

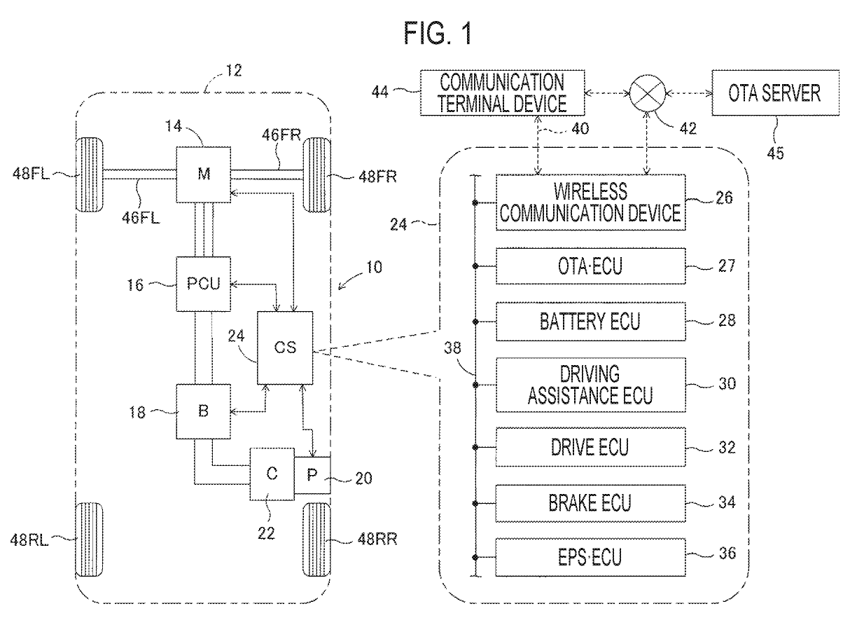

As shown in FIG. 1, the remote parking control device 10 according to the embodiment of the present disclosure is applied to an electrified vehicle 12. The electrified vehicle 12 includes an electric motor (M) 14, a power control unit (PCU) 16, a battery (B) 18, a charging port (P) 20, a charger (C) 22, and a control system (CS) 24. The electrified vehicle 12 is a vehicle capable of autonomous driving. It should be noted that the electrified vehicle 12 may be any electrified vehicle as long as the electrified vehicle 12 is a vehicle equipped with a battery to be charged and driven by using the power of the battery.

The control system 24 includes a wireless communication device 26, an OTA/ECU 27, a battery ECU 28, a driving assistance ECU 30, a drive ECU 32, a brake ECU 34, and an EPS/ECU 36. The ECU means an electronic control unit including a microcomputer as a main part. The EPS is an abbreviation for electric power steering.

The microcomputer of each ECU includes a CPU, a ROM, a RAM, a readable and writable non-volatile memory (N/M), an interface (I/F), and the like. The CPU realizes various functions by executing an instruction (program, routine) stored in the ROM. Further, these ECUs are connected to each other to be capable of exchanging data (communicating) via a controller area network (CAN) 38.

The wireless communication device 26 can wirelessly communicate with a communication terminal device 44, such as a smartphone, via a short-range communication network 40, such as Bluetooth (registered trademark), or a mobile communication network 42. In addition, the wireless communication device 26 can perform wireless communication with an OTA server 45 via the mobile communication network 42.

Although not shown in FIG. 1, the communication terminal device 44 includes a monitor capable of displaying various visual information and a speaker capable of emitting various auditory information. The communication terminal device 44 is operated by the user to transmit and receive signals to and from the wireless communication device 26. The wireless communication device 26 performs signal transmission and reception with the OTA server 45.

The electric motor 14 is driven by power (three-phase alternating current) supplied from the battery 18 through the power control unit 16 during traction. In the embodiment, the electrified vehicle 12 is a front-wheel drive vehicle. In the embodiment, the electric motor 14 drives left and right drive shafts 46FL and 46FR via a reduction gear and a differential gear (not shown in FIG. 1), and thus left and right front wheels 48FL and 48FR are driven. It should be noted that the left and right rear wheels 48RL and 48RR are non-driven wheels, but these wheels may also be driven by an electric motor for rear wheels.

In addition, the electric motor 14 is driven by the rotational energy of the left and right front wheels 48FL and 48FR during deceleration of the electrified vehicle 12, thereby functioning as an electric generator and performing regenerative braking. The power generated by the electric motor 14 is supplied to the battery 18 via the power control unit 16, thereby charging the battery.

The power control unit 16 performs power conversion between the battery 18 and the electric motor 14 and controls the output of the electric motor 14 in response to a command from the battery ECU 28. Although not shown in FIG. 1, the power control unit 16 includes an inverter that converts a direct current supplied from the battery 18 into a three-phase current supplied to the electric motor 14. Although not shown in FIG. 1, the power control unit 16 further includes a converter that adjusts a voltage level of a direct current supplied to the inverter. The power control unit 16 converts the three-phase current supplied from the electric motor 14 into a direct current during regenerative braking and supplies the direct current to the battery 18.

The battery 18 is a chargeable and dischargeable direct current power supply and includes a plurality of secondary batteries such as a lithium ion battery or a nickel-hydrogen battery. The charging plug provided at a distal end of a cable of the charging device during charging of the battery 18 is connected to the charging port 20. The charger 22 supplies the direct current supplied from the charging device to the battery 18 in response to a command from the battery ECU 28 when the charging plug is connected to the charging port 20, and thus charges the battery. The charging of the battery 18 is controlled by the charger 22 being controlled by the battery ECU 28.

In a case where a predetermined condition is satisfied, the CPU of the OTA/ECU 27 performs wireless communication with the OTA server 45 via the wireless communication device 26 and the mobile communication network 42, and inquires whether there is software that can be updated by the OTA by notifying the ID number of the electrified vehicle 12. The CPU stores a response of the OTA server 45 to the inquiry in the readable and writable non-volatile memory, and responds to the inquiry from the driving assistance ECU 30 based on the information stored in the non-volatile memory.

The software update includes three steps of downloading the software from the OTA server 45, installing the software in the readable and writable non-volatile memory of the control device corresponding to the software, and activating the software. The execution of each step is performed by the CPU of the control device corresponding to the software after obtaining the consent of the user by operating the communication terminal device 44.

The driving assistance ECU 30 is a central control device that performs driving assistance controls such as remote parking control, collision avoidance assistance control, and following inter-vehicle distance control. The remote parking control includes a remote parking-in mode and a remote parking-out mode, and the control is started by starting a remote parking application installed in the communication terminal device 44. The mode of the remote parking control is selected by tapping a selection switch displayed on the monitor of the communication terminal device 44.

In a case where the remote parking application is started, the communication terminal device 44 performs wireless communication with the wireless communication device 26 of the control system 24 by using the short-range communication network 40. Then, the communication terminal device 44 transmits a signal indicating that the remote parking application is started to the wireless communication device 26. When a connection capable of transmitting and receiving a signal with the wireless communication device 26 is established, the communication terminal device 44 transmits to the wireless communication device 26 a signal indicating that the connection has been established.

Further, in a case where the remote parking-in mode is selected, the communication terminal device 44 transmits a signal indicating that the remote parking-in mode is selected to the wireless communication device 26. Then, in a case where the remote parking-out mode is selected, the communication terminal device 44 transmits a signal indicating that the remote parking-out mode is selected to the wireless communication device 26. In a case where the signal indicating that the remote parking-in mode is selected is received, the wireless communication device 26 outputs the signal indicating that the remote parking-in mode is selected to the driving assistance ECU 30. Similarly, in a case where the signal indicating that the remote parking-out mode is selected is received, the wireless communication device 26 outputs the signal indicating that the remote parking-out mode is selected to the driving assistance ECU 30.

Although not shown in FIG. 1, a plurality of camera sensors and a plurality of radar sensors are connected to the driving assistance ECU 30. The camera sensor and the radar sensor function as an object information acquisition device that acquires object information around the electrified vehicle 12.

The drive ECU 32 outputs a command signal to the battery ECU 28 such that the driving force generated by the electric motor 14 changes in response to a driving operation by the driver in a normal state. In addition, in a case where the signal of the target driving force is received from the driving assistance ECU 30, the drive ECU 32 outputs the command signal to the battery ECU 28 such that the driving force generated by the electric motor 14 is the target driving force.

Although not shown in FIG. 1, a brake device is connected to the brake ECU 34. The brake device applies the braking force to the front wheels 48FL and 48FR and the rear wheels 48RL and 48RR to decelerate the electrified vehicle 12 by braking. The brake ECU 34 controls the brake device such that the braking force generated by the brake device changes in response to the braking operation by the driver in a normal state. In a case where the command signal is received from the driving assistance ECU 30, the brake ECU 34 performs automatic braking by controlling the brake device based on the command signal.

Although not shown in FIG. 1, the EPS/ECU 36 is connected to the EPS device. The EPS/ECU 36 controls the steering assist torque by controlling the EPS device in a well-known manner in the related art based on the steering torque and the vehicle speed, thereby reducing the steering burden on the driver. In addition, the EPS/ECU 36 can steer, as necessary, the front wheels 48FL and 48FR, which are steering wheels, by controlling the EPS device. Therefore, the EPS/ECU 36 and the EPS device function as an automatic steering device by cooperating with each other.

In the remote parking control, the command signal is output from the driving assistance ECU 30 to the drive ECU 32, the brake ECU 34, and the EPS/ECU 36. As a result, in the remote parking control, the electrified vehicle 12 is moved by the autonomous driving. In particular, in the remote parking-in mode, the electrified vehicle 12 is moved to the target parking-in position by autonomous driving along a target parking-in route selected by the user or a registered parking-in route. In the remote parking-out mode, the electrified vehicle 12 is moved to the target parking-out position by autonomous driving along a target parking-out route selected by the user or a registered parking-out route.

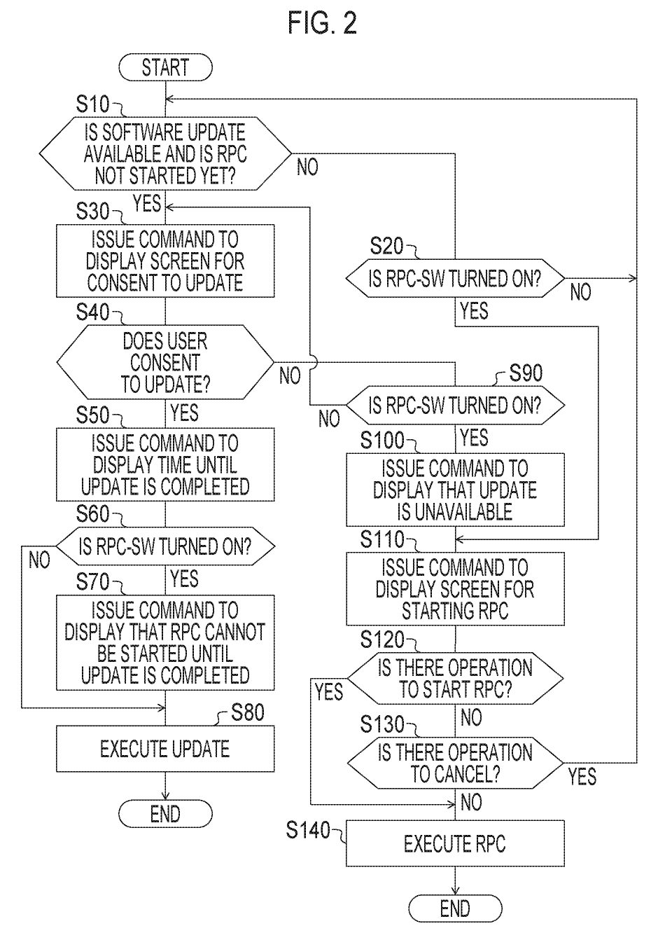

In the embodiment, the ROM of the driving assistance ECU 30 stores the remote parking control program corresponding to the flowchart shown in FIG. 2. In a case where the signal indicating that the remote parking application is started in the communication terminal device 44 is received from the wireless communication device 26, the CPU of the driving assistance ECU 30 starts the remote parking control program and repeatedly executes the remote parking control program at predetermined time intervals. In FIG. 2, the remote parking control is referred to as "RPC" (abbreviation for remote parking control).

In a case where the remote parking application is started in the communication terminal device 44 by the user, a start switch (RPC-SW) of the remote parking control is displayed on the monitor of the communication terminal device. The start switch of the remote parking control includes a "yes" soft button and a "no" soft button for starting the remote parking control, which are operated by the user.

### Remote Parking Control

First, in S10, the CPU determines whether there is software that can be updated by the OTA and the start of the remote parking control has not been performed. The software is software of an on-board control device including an ECU used for the remote parking control. In a case where the positive determination is made, the present control proceeds to S30, and in a case where the negative determination is made, that is, in a case where it is determined that there is no software that can be updated by the OTA, the present control proceeds to S20. In a case where there is software that can be updated by the OTA and the software is software that does not interfere with the remote parking control, the negative determination may be made.

In S20, the CPU determines whether the start switch (RPC-SW) of the remote parking control displayed on the monitor of the communication terminal device 44 is turned on. That is, in S20, the CPU determines whether the user has tapped the "yes" soft button for starting the remote parking control. In a case of the negative determination, the present control returns to S10, and in a case of the positive determination, the present control proceeds to S110.

In S30, the CPU transmits a command to display a screen for consent to software update on the monitor to the communication terminal device 44 via the wireless communication device 26. As a result, the user is notified of the information that the software can be updated and the information on the consent to the software update.

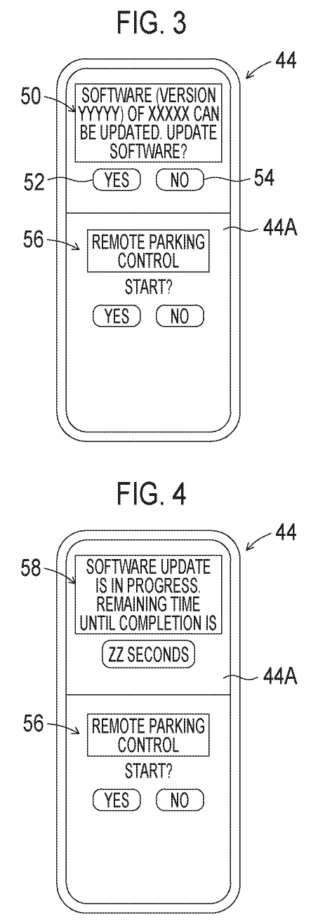

For example, FIG. 3 shows the communication terminal device 44 in which the screen for consent to software update is displayed on the monitor 44A. As shown in FIG. 3, the screen for consent to software update may include information 50 that "Software (version YYYYY) of XXXXX can be updated. Update software?" and a "yes" soft button 52, and a "no" soft button 54.

In addition to these pieces of information, the start switch 56 (the "yes" soft button and the "no" soft button for starting the remote parking control) of the remote parking control is continuously displayed. Therefore, the user can operate the communication terminal device to execute the remote parking control.

In S40, the CPU determines whether the user consents to the software update by tapping the "yes" soft button. In a case of the negative determination, the present control proceeds to S90, and in a case of the positive determination, the present control proceeds to S50.

In S50, the CPU estimates the time until the software update is completed, and transmits a command to display the information on the estimated time in a countdown format on the monitor to the communication terminal device 44 via the wireless communication device 26. As a result, the user is notified of the information on the time until the software update is completed.

For example, FIG. 4 shows the communication terminal device 44 in which information 58 that the software update is being performed and on the time of the countdown until the software update is completed is displayed on the monitor 44A. In addition to the time information, the start switch 56 of the remote parking control is continuously displayed.

In S60, the CPU determines whether the remote parking control switch displayed on the monitor of the communication terminal device 44 is turned on, as in S20. In a case of the negative determination, the present control proceeds to S80, and in a case of the positive determination, the present control proceeds to S70.

In S70, the CPU transmits a command to display the information that the remote parking control cannot be started until the software update is completed on the monitor to the communication terminal device 44 via the wireless communication device 26. As a result, the user is notified of the information that the remote parking control cannot be started until the software update is completed.

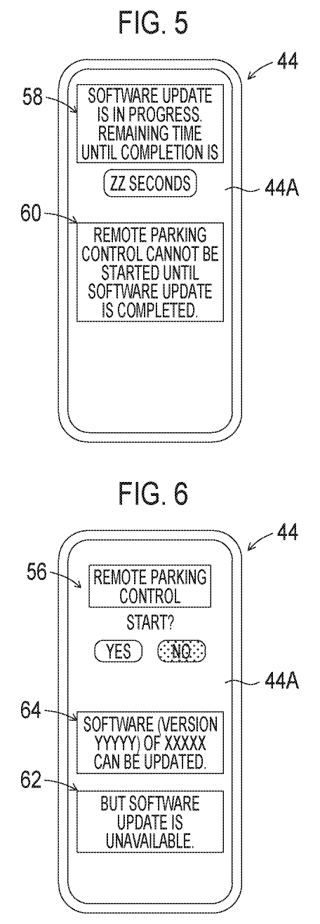

For example, FIG. 5 shows the communication terminal device 44 in which information 60 that the remote parking control cannot be started until the software update is completed is displayed on the monitor 44A. In addition to the information 60 that the remote parking control cannot be started, the information 58 on the time of the countdown until the software update is completed is continuously displayed.

In S80, the CPU executes the update of the software that can be updated. That is, first, the software is downloaded. Then, in a case where the download is completed, a command to display the information that the download is completed and the information on the selection of whether to install the software on the monitor is transmitted to the communication terminal device 44 via the wireless communication device 26. In addition, in a case where the user agrees to the installation, the CPU installs the software. In a case where the installation is completed, the CPU transmits a command to display the information that the installation is completed and the soft button for the selection of whether to activate the software on the monitor to the communication terminal device 44 via the wireless communication device 26. Further, in a case where the user agrees to the activation, the CPU activates the software.

In S90, the CPU determines whether the start switch of the remote parking control displayed on the monitor of the communication terminal device 44 is turned on, as in S20. In a case of the negative determination, the present control returns to S30, and in a case of the positive determination, the present control proceeds to S100.

In S100, the CPU transmits a command to display the information that the software cannot be updated on the monitor to the communication terminal device 44 via the wireless communication device 26. As a result, the user is notified that the software cannot be updated.

For example, FIG. 6 shows the communication terminal device 44 in which information 62 that the software cannot be updated and the start switch 56 of the remote parking control are displayed on the monitor 44A. In addition to the information 62 that the software cannot be updated, information 64 that there is software that can be updated is displayed.

In S110, the CPU transmits a command to display the start screen of the remote parking control on the monitor to the communication terminal device 44 via the wireless communication device 26. As a result, the user can operate the start screen to start the remote parking control. The start screen of the remote parking control may include a "remote parking-in mode" soft button and a "remote parking-out mode" soft button. Further, the start screen of the remote parking control may include a "cancel" soft button, and may include the information that there is software that can be updated in a case where the positive determination is made in S40.

In S120, the CPU determines whether the user has performed the start operation of the remote parking control, for example, whether the "remote parking-in mode" soft button or the "remote parking-out mode" soft button has been tapped. In a case of the positive determination, the present control proceeds to S140, and in a case of the negative determination, the present control proceeds to S130.

In S130, the CPU determines whether the user has performed the cancel operation of the remote parking control, for example, whether the "cancel" soft button has been tapped. In a case of the negative determination, the present control returns to S10, and in a case of the positive determination, the present control proceeds to S140.

In S140, the CPU executes the remote parking control in the mode selected in S120. The remote parking control may be executed in any manner well known in the related art in a case where the mode is any of the remote parking-in mode and the remote parking-out mode.

### Example of Operation of Embodiment

Examples of the operation of the embodiment will be described for various cases in which the situation is different, such as whether there is software that can be updated by the OTA, whether the user consents to the software update, and whether the user consents to the start of the remote parking control. As described above, in a case where the remote parking application is started in the communication terminal device 44 by the user, the start switch of the remote parking control is displayed on the monitor of the communication terminal device, and the remote parking control is executed according to the flowchart shown in FIG. 2.

### 1. Case where There is No Software That Can Be Updated by OTA

In S10, the negative determination is made. In a case where the user taps the "yes" soft button for starting the remote parking control, in S20, the positive determination is made, and in S110, the start screen of the remote parking control is displayed on the monitor of the communication terminal device 44. In a case where the user performs the start operation of the remote parking control, in S120, the positive determination is made, and in S140, the remote parking control is executed.

### 2. Case where There is Software That Can Be Updated by OTA and User Consents to Update

In S10, the positive determination is made, and in S30, the screen for consent to software update is displayed on the monitor of the communication terminal device 44. In a case where the user consents to the software update, in S40, the positive determination is made, and in S50, the time until the software update is completed is displayed on the monitor of the communication terminal device 44 in a countdown format.

In a case where the user does not tap the "yes" soft button for starting the remote parking control, in S60, the negative determination is made, and in S80, the software update is executed. On the other hand, in a case where the user taps the "yes" soft button for starting the remote parking control, in S60, the positive determination is made. Further, in S70, the information that the remote parking control cannot be started until the software update is completed is displayed on the monitor of the communication terminal device 44, and in S80, the software update is executed.

### 3. Case where There is Software That Can Be Updated by OTA, and User Does Not Consent to Update and Does Not Consent to Start of Remote Parking Control

In S10, the positive determination is made, and in S30, the screen for consent to software update is displayed on the monitor of the communication terminal device 44. Since the user does not consent to the software update, in S40, the negative determination is made. Since the user does not tap the "yes" soft button for starting the remote parking control, in S90, the negative determination is made, and S30 and S40 are performed again. Therefore, in a case where the user consents to the software update, in S40, the positive determination is made, and the software update is executed as in the case of 2.

### 4. Case where There is Software That Can Be Updated by OTA, and User Does Not Consent to Update but Consents to Start of Remote Parking Control

As in the case of 3, in S10, the positive determination is made, and in S30, the screen for consent to software update is displayed on the monitor of the communication terminal device 44. Since the user does not consent to the software update, in S40, the negative determination is made. Since the user taps the "yes" soft button for starting the remote parking control, in S90, the positive determination is made. Therefore, as in the case of 1, the remote parking control is executed.

In this case, in S100, the information that there is software that can be updated and the information that the software cannot be updated are displayed on the monitor of the communication terminal device 44. Therefore, the user can recognize that the remote parking control is performed in a situation where there is software that can be updated by the OTA.

As described above, according to the embodiment, in a case where the wireless connection with the communication terminal device 44 is completed and a situation in which software can be updated is reached (S10), the user is notified that the software can be updated (S30). Therefore, the user can recognize that the software can be updated, and can determine whether to update the software without executing the remote parking control.

In addition, in a case where the user is notified that the software can be updated but does not consent to the software update (S40), the user can operate the communication terminal device to execute the remote parking control without updating the software (S30, S90). Therefore, the user can execute the remote parking control by operating the communication terminal device 44, and can prevent the software from being updated in a case where the remote parking control is executed. Therefore, since the remote parking control and the software update are not executed at the same time, it is possible to prevent the remote parking control and the software update from interfering with each other.

In addition, according to the embodiment, in a situation where the user is allowed to operate the communication terminal device 44 to execute the remote parking control, the user is notified that software cannot be updated in a case where the user operates the communication terminal device 44 to execute the remote parking control (S100). Therefore, the user can recognize that the software update cannot be performed in a case where the user operates the communication terminal device to execute the remote parking control.

In addition, according to the embodiment, in a case where the user consents to the software update (S40), the remote parking control is not executed (S80) even in a case where the user operates the communication terminal device 44 to execute the remote parking control (S60). Therefore, in a case where the user consents to the software update and the software is updated, the remote parking control is not executed even in a case where the communication terminal device 44 is operated to execute the remote parking control. Therefore, it is possible to prevent the remote parking control and the software update from being executed at the same time, and to prevent the remote parking control and the software update from interfering with each other.

In addition, according to the embodiment, in a case where the user operates the communication terminal device 44 to execute the remote parking control (S60) even in a case where the user consents to the software update (S40), the user is notified that the remote parking control cannot be started until the software update is completed (S70). Therefore, the user can recognize that the remote parking control cannot be started until the software update is completed, and it is possible to reduce the risk that the user operates the communication terminal device 44 to execute the remote parking control.

Further, according to the embodiment, in a case where the user consents to the software update (S40), the user is notified of the time until the software update is completed by a countdown (S70). Therefore, the user can recognize the time until the software update is completed, and can know a timing at which the software update is completed and the remote parking control can be executed.

In the above, the present disclosure has been described in detail with reference to specific embodiments, but the present disclosure is not limited to the above-described embodiments, and it will be apparent to those skilled in the art that various other embodiments are possible within the scope of the present disclosure.

For example, in the above-described embodiment, the remote parking control includes the remote parking-in mode and the remote parking-out mode. Then, the remote parking control can be executed in any of the remote parking-in mode or the remote parking-out mode by the selection of the user. However, the remote parking control may be performed only in one of the remote parking-in mode or the remote parking-out mode.

In addition, in the above-described embodiment, in S10, it is determined whether there is software that can be updated by the OTA and the start of the remote parking control has not been performed. The software update includes three steps of downloading the software from the OTA server, installing the software in the control device corresponding to the software, and activating the software. However, even in a case where there is software that is downloaded from the OTA server and the software is installed and activated, it may be determined that there is software that can be updated by the OTA.

In addition, in the above-described embodiment, in a case where the negative determination is made in S60 or in a case where the positive determination is made in S60 and S70 is performed, the software update is executed in S80. However, before S80, it is determined whether the user has canceled the software update, and in a case where the user has canceled the software update, the software update may be canceled.

Further, in the above-described embodiment, in S30 and the like, the user operates the soft switch or the soft button displayed on the monitor 44A of the communication terminal device 44. However, a physical switch, a button, or the like may be provided in the communication terminal device, and these may be operated by the user.

Further, in the above-described embodiment, in S30, S50, S70, S100 and S110, the user is notified of the visual information by displaying the visual information on the monitor of the communication terminal device 44. However, the notification to the user may be performed by emitting the auditory information from the speaker, or may be performed by both the display of the visual information and the emission of the auditory information.

Further, in the above-described embodiment, the electrified vehicle 12 is an electrified vehicle driven by the electric motor 14. However, as long as the software can be updated by the OTA and the remote parking control can be executed by the user operating the communication terminal device, the vehicle to which the remote parking control device according to the present disclosure is applied may be any vehicle well known in the related art. For example, the vehicle may be a vehicle such as an internal combustion engine vehicle, a hybrid electric vehicle, a plug-in hybrid electric vehicle, or a fuel cell electric vehicle.

What is claimed is:

1. A remote parking control device for a vehicle, the remote parking control device comprising a control unit that is wirelessly connected to a communication terminal device operated by a user, is configured to execute remote parking control in response to a command from the communication terminal device, and is configured to acquire software of an on-board control device and update the software via wireless communication,
wherein the control unit is configured to issue a command to the communication terminal device to notify the user that a software update is available, in a case where wireless connection with the communication terminal device is completed and a situation arises in which the software update is available, and is configured to enable the user to operate the communication terminal device to execute the remote parking control without updating the software, in a case where the user is notified that the software update is available but does not consent to the software update.

2. The remote parking control device according to claim 1, wherein the control unit is configured to issue a command to the communication terminal device to notify the user that the software update is unavailable, in a situation where the user is allowed to operate the communication terminal device to execute the remote parking control, and in a case where the user operates the communication terminal device to execute the remote parking control.

3. The remote parking control device according to claim 1, wherein the control unit is configured not to execute the remote parking control even when the user operates the communication terminal device to execute the remote parking control, in a case where the user consents to the software update.

4. The remote parking control device according to claim 1, wherein the control unit is configured to issue a command to the communication terminal device to notify the user that start of the remote parking control is unavailable until the software update is completed, in a case where the user operates the communication terminal device to execute the remote parking control despite having consented to the software update.

5. The remote parking control device according to claim 1, wherein the control unit is configured to issue a command to the communication terminal device to notify the user of a time until the software update is completed by a countdown, in a case where the user consents to the software update.
